(19) United States
(12) Patent Application Publication
(10) Pub. No.: US 2020/0184290 A1
(43) Pub. Date: Jun. 11, 2020

(54) IMAGE FORMING DEVICE, IMAGE FORMING SYSTEM, IMAGE FORMING SYSTEM CONTROL METHOD, AND NON-TRANSITORY COMPUTER-READABLE RECORDING MEDIUM STORING A PROGRAM

(71) Applicant: KONICA MINOLTA, INC., Tokyo (JP)

(72) Inventor: Tatsuyoshi HAGA, Tokyo (JP)

(73) Assignee: KONICA MINOLTA, INC., Tokyo (JP)

(21) Appl. No.: 16/596,926

(22) Filed: Oct. 9, 2019

(30) Foreign Application Priority Data
Dec. 11, 2018 (JP) 2018-231695

(51) Int. Cl. G06K 15/00

(52) U.S. Cl. CPC G06K 15/408; G06K 15/005

(57) ABSTRACT

An image forming device and an image forming system which can perform a sheet setting process for a sheet on which an image or text has already been formed, an image forming system control method, and a non-transitory computer-readable recording medium storing a program. The image forming device includes a communication section, a determination section, and a notifying section. The communication section receives, from a sheet detector for detecting a physical property value of a sheet, detected information acquired by detecting the sheet. The determination section determines whether the detected information meets a given condition or not. If the determination section determines that the given condition is not met, the notifying section notifies a user that the given condition is not met.

### CROSS-REFERENCE TO RELATED APPLICATIONS

The entire disclosure of Japanese Patent Application No. 2018-231695, filed on Dec. 11, 2018, is incorporated herein by reference in its entirety.

### BACKGROUND

### Technological Field

The present invention relates to an image forming device for forming an image on a sheet of paper, an image forming system, an image forming system control method, and a non-transitory computer-readable recording medium storing a program.

### Description of the Related Art

The image forming system includes an image forming device for forming an image on a sheet of paper, and a paper feed unit for supplying paper to the image forming device. The image forming device forms an image on a sheet of paper according to output job information. Also, the image forming device performs the process to identify the sheet size and type and set (specify) the sheet for image formation, before forming an image on a sheet.

Conventionally, this kind of image forming system has been disclosed, for example, by Patent Literature 1 (JP-A-2013-90050). Patent Literature 1 describes an image forming device which includes: acquisition portion to acquire the brightness value of the white area of the paper housed in a paper feed stage upon detection of opening/closing of the paper feed stage; and correction portion to correct the tone of the image printed on the paper housed in the paper feed stage. The image forming device further includes determination portion to determine, from the brightness value acquired by the acquisition means, the brightness-density conversion characteristics which are used for the correction portion to correct the tone of the image printed on the paper housed in the paper feed stage. In the technique described in Patent Literature 1, the information on the brightness-density conversion characteristics determined by the determination portion is associated with the information on the paper feed stage housing the paper whose brightness value has been acquired by the acquisition portion.

### CITATION LIST

### Patent Literature

Patent Literature 1: JP-A-2013-90050

### SUMMARY

In addition, overprinting is often made to form an image newly on a sheet on which an image or text has already been formed. However, in the technique described in Patent Literature 1, no consideration is given to overprinting and it is difficult to accurately determine the brightness-density conversion characteristics of the sheet on which an image or text has already been formed, so it is impossible to perform the sheet setting process adequately.

The present invention has been made in view of the above existing problem and has an object to provide an image forming device and an image forming system which can perform a sheet setting process for a sheet on which an image or text has already been formed, an image forming system control method, and a non-transitory computer-readable recording medium storing a program.

To achieve the abovementioned object, according to one aspect of the present invention, an image forming device reflecting one aspect of the present invention comprises a communication section, a determination section, and a notifying section. The communication section receives, from a sheet detector for detecting a physical property value of a sheet, detected information acquired by detecting the sheet. The determination section determines whether the detected information received by the communication section meets a given condition or not. If the determination section determines that the given condition is not met, the notifying section notifies a user that the information detected by the sheet detector does not meet the given condition.

According to a second aspect of the present invention, an image forming system reflecting one aspect of the present invention comprises a sheet detector which detects a physical property value of a sheet; and an image forming device which forms an image on the sheet. The image forming system further comprises a determination section and a notifying section. The determination section determines whether the information detected by the sheet detector meets a given condition or not. If the determination section determines that the given condition is not met, the notifying section notifies a user that the information detected by the sheet detector does not meet the given condition.

According to a third aspect of the present invention, an image forming system control method reflecting one aspect of the invention uses a non-transitory computer-readable recording medium storing a program causing a computer to perform:

(1) detecting a physical property value of a sheet and sending detected information to a determination section;
(2) determining whether the detected information meets a given condition or not; and
(3) if it is determined that the given condition is not met, notifying a user that the given condition is not met.

According to a fourth aspect of the present invention, a non-transitory computer-readable recording medium reflecting one aspect of the invention stores a program causing a computer to perform:

detecting a physical property value of a sheet and acquiring detected information;

causing a determination section to determine whether the detected information meets a given condition or not; and

if the determination section determines that the given condition is not met, causing a notifying section to notify a user that the given condition is not met.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram which shows the general configuration of an image forming system according to an embodiment of the present invention;

FIG. 2 is a block diagram which shows the hardware configuration of the image forming system according to the embodiment of the present invention;

FIG. 3 is an explanatory view which shows an example of a sheet on which an image or text has already been formed;

FIG. 4 is a flowchart which shows a first operation example of the sheet setting process in the image forming system according to the embodiment of the present invention;

FIG. 5 is an example of a display in the first operation example of the sheet setting process in the image forming system according to the embodiment of the present invention;

FIG. 6 is a flowchart which shows a second operation example of the sheet setting process in the image forming system according to the embodiment of the present invention;

FIGS. 7A and 7B are explanatory views which show the detection area and the sheet transportation direction in the image forming system according to the embodiment of the present invention, in which FIG. 7A shows that the sheet white area does not pass through the detection area and FIG. 7B shows that the sheet white area passes through the detection area;

FIG. 8 shows an example of a display in a second operation example of the sheet setting process in the image forming system according to the embodiment of the present invention; and

FIG. 9 is a flowchart which shows a third operation example of the sheet setting process in the image forming system according to the embodiment of the present invention.

### DETAILED DESCRIPTION OF EMBODIMENTS

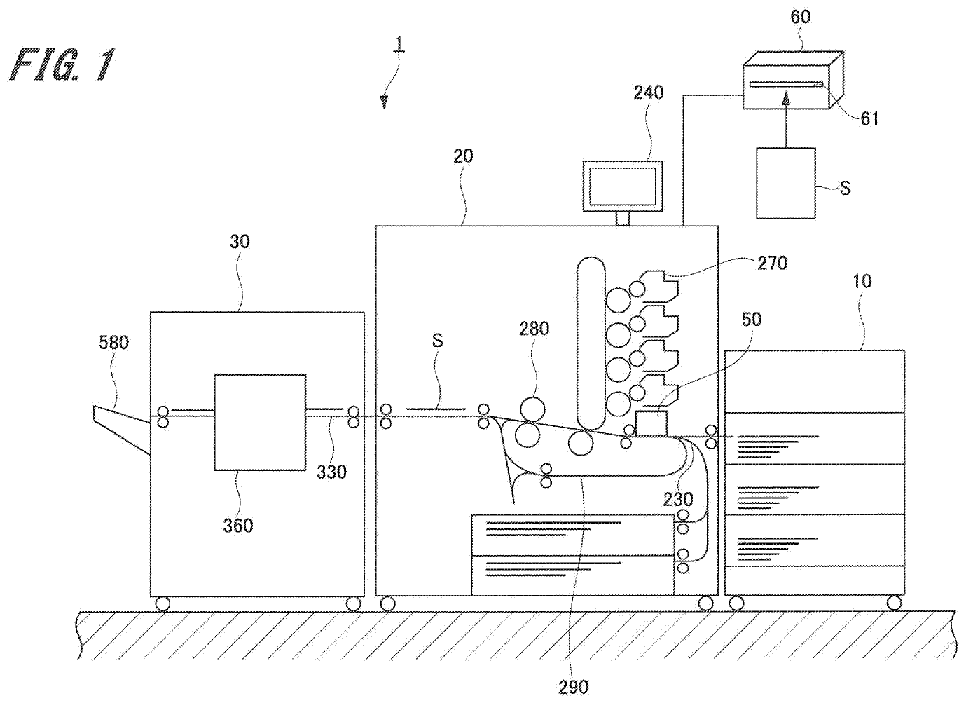

Hereinafter, an image forming device, an image forming system, an image forming system control method, and a non-transitory computer-readable recording medium storing a program according to embodiment of the present invention will be described with reference to FIGS. 1 to 9. In the figures, the same members are designated by the same reference signs. However, the scope of the invention is not limited to the disclosed embodiment.

### 1. Embodiments

### 1-1. Configuration of the Image Forming System

First, the general configuration of the image forming system according to an embodiment of the present invention (hereinafter called “present embodiment”) will be described. FIG. 1 is a schematic configuration diagram of the image forming system according to the present embodiment.

As shown in FIG. 1, an image forming system 1 includes a large-capacity paper feed unit 10 for supplying sheets S, an image forming device 20, and an image reader 30. Also, the image forming system 1 includes an inline media sensor 50 and an offline media sensor 60 as sheet detectors. The large-capacity paper feed unit 10, image forming device 20, image reader 30, inline media sensor 50, and offline media sensor 60 are connected to a network such as a LAN and connected with each other through the network. In the image forming system 1, the large-capacity paper feed unit 10, image forming device 20, and image reader 30 are arranged in order from the upstream side of the transportation path for sheets S and connected in series.

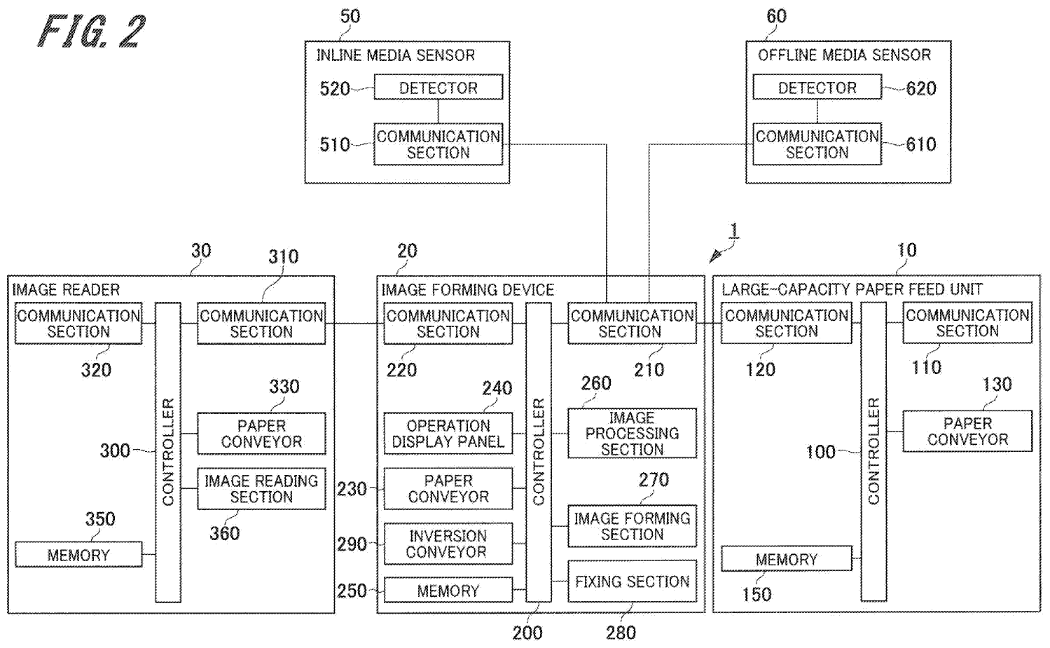

The large-capacity paper feed unit 10 is located on the most upstream side of the image forming system 1. The large-capacity paper feed unit 10 has a plurality of paper feed trays and can house a large quantity of sheets. The large-capacity paper feed unit 10 supplies the sheets S housed in a paper feed tray to the image forming device 20 through a paper conveyor 130 (see FIG. 2).

The image forming device 20 forms an image on a supplied sheet S according to output job information and image data. The image forming device 20 adopts an electrophotographic method to form an image on a sheet S. The image forming device 20 includes a paper conveyor 230, an operation display panel 240, an image forming section 270, a fixing section 280, and an inversion conveyor 290.

The operation display panel 240 as a notifying section is located over the housing of the image forming device 20. The operation display panel 240 includes a display panel and a touch panel (operation section) which are placed one upon the other so as to enable operation by the user and display of information.

The paper conveyor 230 transports the sheet S supplied from the large-capacity paper feed unit 10 to the image forming section 270, fixing section 280, inversion conveyor 290, and image reader 30 which will be described later.

The image forming section 270 includes, for example, image forming units for a plurality of colors (cyan, magenta, yellow, black, etc.) and can form a color image on a sheet. The fixing section 280 is located on the downstream of the image forming section 270 in the sheet transportation direction to which the sheet with a toner image formed thereon is transported.

The fixing section 280 fixes the transferred toner image on the sheet S by pressurizing and heating the transported sheet S. The sheet S subjected to the fixing process by the fixing section 280 is transported to the inversion conveyor 290 or image reader 30 by the paper conveyor 230.

The inversion conveyor 290 includes an inversion section which inverts the sheet S. The sheet S inverted upside down or back and forth by the inversion section is made to pass through the inversion conveyor 290 and transported to the upstream side of the image forming section 270 or the downstream side of the fixing section 280.

The image reader 30 is a device which reads the image formed on the sheet S transported from the image forming device 20. The image reader 30 includes a paper conveyor 330 for transporting sheets and an image reading section 360 for reading an image. The image reading section 360 lies above and below the paper conveyor 330. The image reading section 360 reads the information (image) formed on the sheet S by scanning the sheet S transported by the paper conveyor 330 optically and generates read image data.

The inline media sensor 50 is installed in the image forming device 20. The inline media sensor 50 is located upstream of the image forming section 270 of the image forming device 20 in the sheet transportation direction. The location of the inline media sensor 50 is not limited to the above; instead, for example, the inline media sensor 50 may be located in the delivery section through which the sheets S in the large-capacity paper feed unit 10 are delivered to the image forming device 20 or may be located between the large-capacity paper feed unit 10 and the image forming device 20. Alternatively, the inline media sensor 50 may be located in the delivery part of the paper feed tray which houses the sheets S in the image forming device 20.

The inline media sensor 50 includes a detector 520 (see FIG. 2) which detects a physical property value of the sheet S transported from the large-capacity paper feed unit 10 for the sheet setting process. The inline media sensor 50 sends the detected information to the image forming device 20.

The offline media sensor 60 is separately installed in a different place from the image forming device 20. The offline media sensor 60 is used for the sheet setting process. The offline media sensor 60 has an insertion hole 61 into which the sheet S to be subjected to the setting process is inserted. A detector 620 (see FIG. 2) which detects a physical property value of the sheet S is provided inside the insertion hole 61. The offline media sensor 60 sends the detected information to the image forming device 20.

The physical properties which are detected by the inline media sensor 50 and offline media sensor 60 are, for example, the basis weight, thickness, surface nature, base (ground), and color of the sheet S.

### 1-2. Hardware Configurations of the Various Devices

Next, the hardware configurations of the various devices will be described referring to FIG. 2.

FIG. 2 is a block diagram which shows the hardware configurations of the various devices of the image forming system.

First, the hardware configuration of the large-capacity paper feed unit 10 will be described.

As shown in FIG. 2, the large-capacity paper feed unit 10 includes a controller 100, communication sections 110 and 120, the paper conveyor 130, and a memory 150.

The controller 100 has, for example, a CPU (Central Processing Unit). The controller 100 is connected to the communication sections 110 and 120, paper conveyor 130, and memory 150 through a system bus to control the entire large-capacity paper feed unit 10.

The memory 150 is a volatile memory such as a RAM or a large-capacity nonvolatile memory. The memory 150 stores the program to be executed by the controller 100 or the like and is used as a working area for the controller 100.

The communication section 110 performs transmission and reception of data with an external device (client terminal, management device server, mobile terminal, etc.) of the image forming system 1. The communication section 120 performs transmission and reception of data with the communication section 210 of the image forming device 20.

Next, the hardware configuration of the image forming device 20 will be described.

The image forming device 20 includes a controller 200, communication sections 210 and 220, the paper conveyor 230, the operation display panel 240, a memory 250, an image processing section 260, the image forming section 270, the fixing section 280, and the inversion conveyor 290.

The controller 200 as a determination section has, for example, a CPU (Central Processing Unit). The controller 200 is connected to the communication sections 210 and 220, paper conveyor 230, operation display panel 240, memory 250, image processing section 260, image forming section 270, fixing section 280, and inversion conveyor 290 through the system bus to control the entire image forming device 20. Also, the controller 200 controls the large-capacity paper feed unit 10, image reader 30, inline media sensor 50, and offline media sensor 60 through the communication sections 210 and 220. In short, in the present embodiment, the controller 200 controls the entire image forming system 1.

The memory 250 as a storage is a volatile memory such as a RAM or a large-capacity nonvolatile memory. The memory 250 stores the program to be executed by the controller 200 or the like and is used as a working area for the controller 200. Also, the memory 250 stores the sheet setting information which indicates the size and type of the sheet S to be set. The sheet S setting items are, for example, the base color, paper type, and basis weight of the sheet S.

The communication section 210 performs transmission and reception of data with the communication section 120 of the large-capacity paper feed unit 10. Also, the communication section 210 performs transmission and reception of data with the communication section 510 of the inline media sensor 50 and the communication section 610 of the offline media sensor 60. The communication section 220 performs transmission and reception of data with the communication section 310 of the image reader 30. The communication sections 210 and 220 also perform transmission and reception of data with the external device of the image forming system 1.

The image processing section 260 acquires image data from the job information received from outside and performs image processing. The image processing section 260 performs image processing tasks, including shading correction, image density adjustment, and image compression, on the received image data as necessary under the control by the controller 200. Then, the image data processed by the image processing section 260 is sent to the image forming section 270. The image forming section 270 receives the image data processed by the image processing section 260 and forms an image on a sheet S according to the image data.

The operation display panel 240 is a touch panel as a display such as a liquid crystal display unit (LCD) or organic ELD (Electro Luminescence Display). This operation display panel 240 is an example of the output and input section which displays an instruction menu for the user, information concerning the acquired image data, and the like. The operation display panel 240 includes a plurality of keys and receives various instructions and data such as characters and numerals which are entered by the user through key operation, and sends an input signal to the controller 200.

Next, the hardware configuration of the image reader 30 will be described.

The image reader 30 includes a controller 300, communication sections 310 and 320, the paper conveyor 330, the image reading section 360, and a memory 350.

The controller 300 has, for example, a CPU (Central Processing Unit). The controller 300 is connected to the communication sections 310 and 320, paper conveyor 330, memory 350, and image reading section 360 through the system bus to control the entire image reader 30.

The memory 350 is a volatile memory such as a RAM or a large-capacity nonvolatile memory. The memory 350 stores the program to be executed by the controller 300 or the like and is used as a working area for the controller 300.

The communication section 310 performs transmission and reception of data with the communication section 220 of the image forming device 20. The communication section 310 sends the image reading result information read by the image reading section 360 to the communication section 220 of the image forming device 20. Furthermore, the communication section 310 receives the image determination result from the image forming device 20 through the communication section 220. Also, the communication section 320 performs transmission and reception of data with a device connected downstream of the image reader 30 in the transportation direction, for example, a post-processing device or stacker.

Next, the hardware configuration of the inline media sensor 50 will be described.

The inline media sensor 50 includes a communication section 510 which performs transmission and reception of data with the image forming device 20, and the detector 520. The detector 520 includes an optical sensor or mechanical sensor and detects the size and type of the sheet S passing through the transportation path of the image forming device 20. The information detected by the detector 520 is sent to the image forming device 20 through the communication section 510.

Next, the hardware configuration of the offline media sensor 60 will be described.

The offline media sensor 60 includes a communication section 610 which performs transmission and reception of data with the image forming device 20, and the detector 620. The detector 620 includes an optical sensor or a mechanical sensor like the detector 520 of the inline media sensor 50 and detects the size and type of the sheet S inserted into the insertion hole 61. The information detected by the detector 620 is sent to the image forming device 20 through the communication section 610.

### 2. Examples of Operation

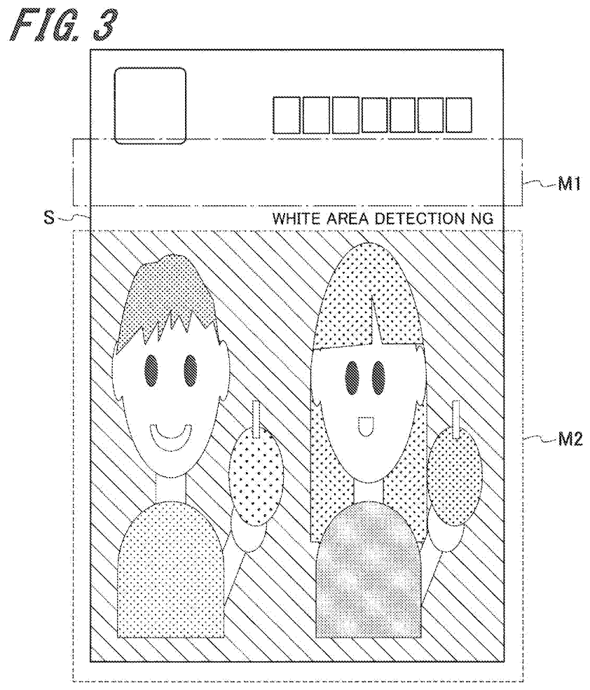

Next, an operation example of the sheet setting process in the image forming system 1 configured as mentioned above will be described referring to FIGS. 3 to 9.

2-1. Example of the Sheet for which the Setting Process is Performed

First, an example of the sheet for which the setting process is performed is explained below referring to FIG. 3.

FIG. 3 is an explanatory view which shows an example of the sheet.

The sheet S shown in FIG. 3 is a postcard as an example of the sheet on which an image or text has been formed in advance. As shown in FIG. 3, the sheet S has a base area M1 on which an image or text has not been formed, and an image area M2 on which an image or text has been formed. In the base area M1, the base (white base in the example shown in FIG. 3) can be detected by the detector 520 of the inline media sensor 50 or the detector 620 of the offline media sensor 60 since no image or text has been formed. On the other hand, in the image area M2, in which an image or text has been formed, the base cannot be detected by the detector 520 or 620.

### 2-2. First Operation Example of the Setting Process

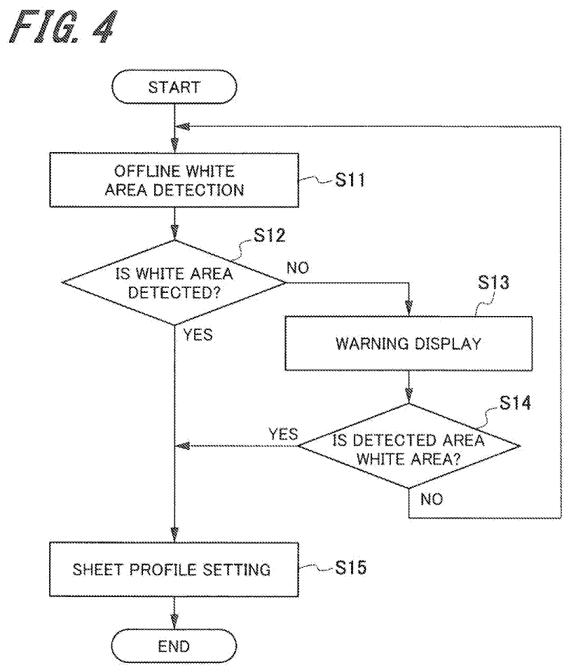

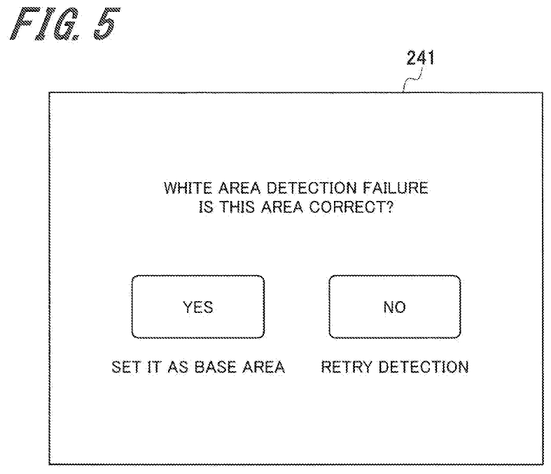

Next, as a first operation example of the setting process, the case that the offline media sensor 60 is used will be explained referring to FIGS. 4 and 5.

FIG. 4 is a flowchart which shows the first operation example of the sheet setting process and FIG. 5 shows an example of a display which appears on the operation display panel 240 in the first operation example.

As shown in FIG. 1, the user inserts a sheet S into the insertion hole 61 of the offline media sensor 60. Then, the white area of the sheet S is detected using the detector 620 of the offline media sensor 60 (Step S11). The offline media sensor 60 sends the information detected by the detector 620 to the controller 200 of the image forming device 20 through the communication section 610. The controller 200 determines whether the white area has been detected according to the detected information sent from the detector 620 or not (Step S12). Here, the white area refers to the base area M1 shown in FIG. 3.

If at Step S12 the controller 200 determines that the white area has not been detected (determination at Step S12: NO), it gives a warning display (Step S13). At Step S13, for example, the controller 200 causes a display as shown in FIG. 5 to appear on a display screen 241 of the operation display panel 240. By giving the display as shown in FIG. 5 on the display screen 241, the controller 200 notifies the user of the need to change the orientation of the sheet S for insertion into the insertion hole 61 of the offline media sensor 60. Furthermore, the controller 200 prompts the user to determine whether the detected area is the white area or not (Step S14).

If at Step S12 the controller 200 determines that the white area has been detected (determination at Step S12: YES), it compares the detected information sent from the detector 620 with the sheet setting information stored in the memory 250 in advance. Then, the controller 200 sets a sheet profile for the sheet S according to the detected information and the sheet setting information (Step S15). Also, the controller 200 sets the sheet profile information set at Step S15 for the paper feed tray which houses the sheet S.

If at Step S14 the user operates the operation display panel 240 so as to tell that the detected area is the white area (determination at Step S14: YES), the controller 200 searches for a sheet profile approximate to the detected information sent from the detector 620 among the pieces of sheet setting information stored in the memory 250 in advance. Then, the controller 200 sets the approximate sheet profile as the sheet profile of the sheet S (Step S15). Also, the controller 200 sets the sheet profile information set at Step S15 for the paper feed tray which houses the sheet S.

If at Step S14 the user operates the operation display panel 240 so as to tell that the detected area is not the white area (determination at Step S14: NO), the controller 200 returns to Step S11. Then, the user should change the orientation of the sheet S for insertion into the insertion hole 61 and retry the process to detect the white area of the sheet S.

The above steps are repeated and if the base area (white area) is not detected, the user is notified of the detection failure and prompted to take a remedial action, so the sheet setting process can be performed even for the sheet S on which an image or text has already been formed.

### 2-3. Second Operation Example of the Sheet Setting Process

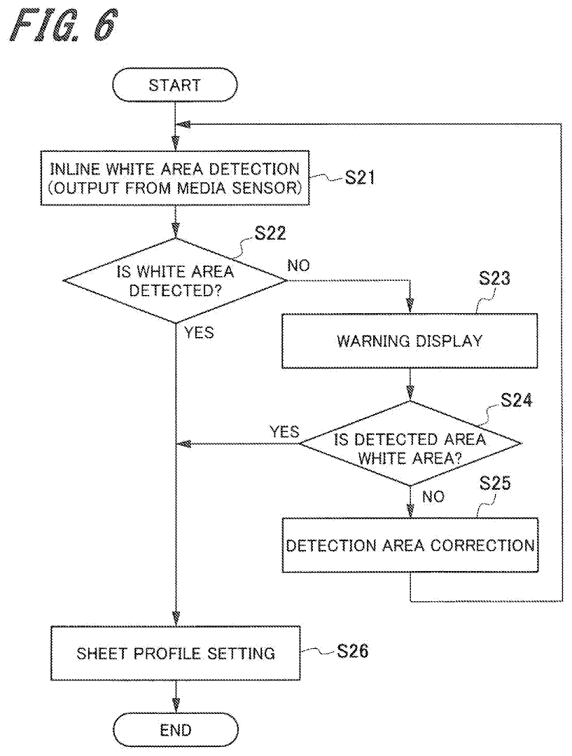

Next, as a second operation example of the setting process, the case that the inline media sensor 50 is used will be explained referring to FIGS. 6 to 8.

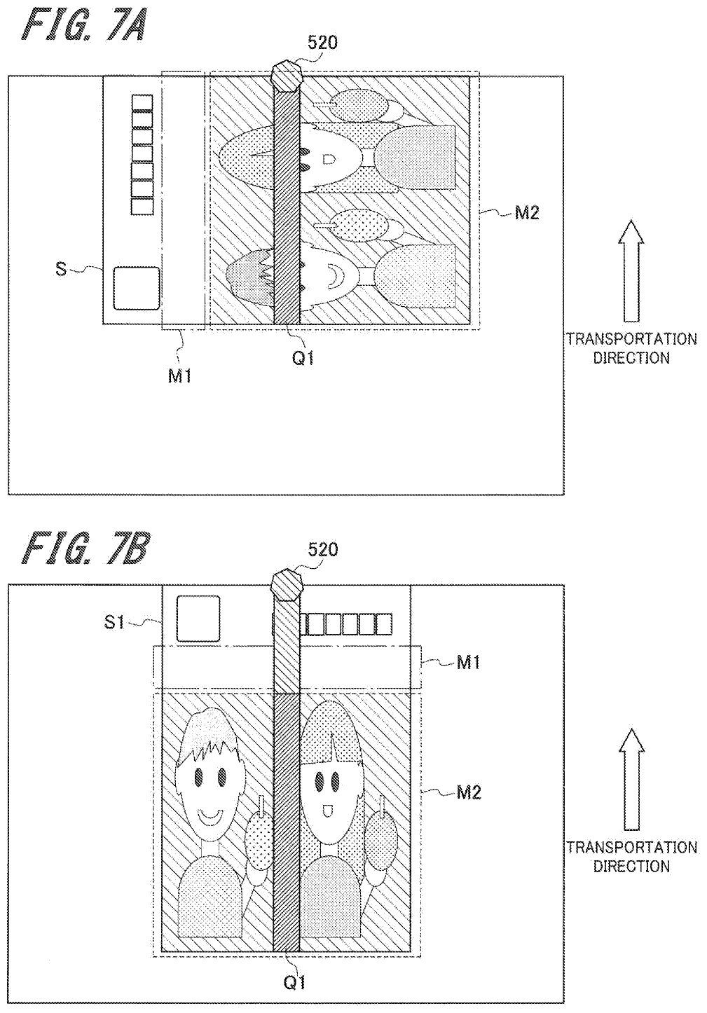

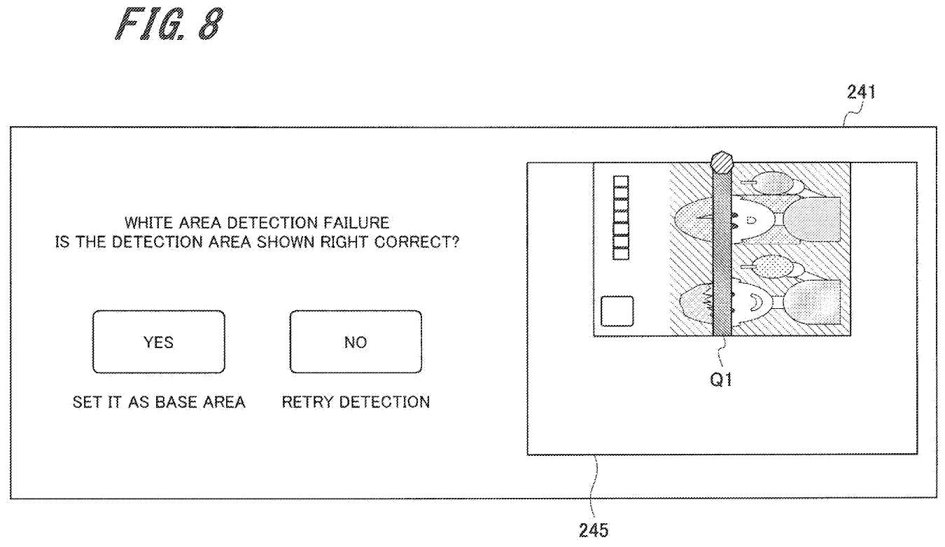

FIG. 6 is a flowchart which shows the second operation example of the sheet setting process; FIGS. 7A and 7B are explanatory views which show the detection area covered by the detector 520 and the orientation of the sheet S with respect to the transportation direction; and FIG. 8 shows an example of a display which appears on the operation display panel 240 in the second operation example.

In the second operation example, the image forming system 1 activates the large-capacity paper feed unit 10, image forming device 20, and image reader 30 for the sheet setting process. Specifically, the sheet S for the setting process is transported from the large-capacity paper feed unit 10 or the paper feed tray of the image forming device 20. In the sheet setting process, the image forming section 270 does not perform the image forming process.

Then, the detector 520 of the inline media sensor 50 detects the white area of the transported sheet S (Step S21). The inline media sensor 50 sends the information detected by the detector 520 to the controller 200 of the image forming device 20 through the communication section 510. The controller 200 determines whether the white area has been detected according to the detected information sent from the detector 520 or not (Step S22).

If the detector 520 is placed in the center in the width direction perpendicular to the sheet S transportation direction, the detection area Q1 covered by the detector 520 lies in the center in the width direction. Therefore, as shown in FIG. 7A, the base area M1 may not pass through the detection area Q1 covered by the detector 520 depending on the orientation of the sheet S being transported. In this case, the detector 520 cannot detect the white area of the sheet S.

If at Step S22 the controller 200 determines that the white area has not been detected (determination at Step S22: NO), it gives a warning display (Step S23). At Step S13, for example, the controller 200 causes a display as shown in FIG. 8 to appear on the display screen 241 of the operation display panel 240. As shown in FIG. 8, the display screen 241 may show the detection area Q1 covered by the detector 520, together with the image on the sheet S as read by the image reader 30, as a thumbnail 247. Consequently, the user can be notified of the orientation of the sheet S with respect to the transportation direction which enables the detector 520 to detect the white area.

Next, the controller 200 causes a display as shown in FIG. 8 to appear on the display screen 241 and prompts the user to determine whether the detected area is the white area or not (Step S24).

On the other hand, as the base area M1 of the sheet S passes through the detection area Q1 covered by the detector 520 as shown in FIG. 7B, the detector 520 can detect the white area of the sheet S. Then, if at Step S22 the controller 200 determines that the white area has been detected (determination at Step S22: YES), it compares the detected information sent from the detector 520 with the sheet setting information stored in the memory 250 in advance. Then, the controller 200 sets a sheet profile for the sheet S according to the detected information and the sheet setting information (Step S26). Also, the controller 200 sets the sheet profile information set at Step S26 for the paper feed tray which houses the sheet S.

If at Step S24 the user operates the operation display panel 240 so as to tell that the detected area is the white area (determination at Step S24: YES), the controller 200 searches for a sheet profile approximate to the detected information sent from the detector 520 among the pieces of sheet setting information stored in the memory 250 in advance. Then, the controller 200 sets the approximate sheet profile as the sheet profile of the sheet S (Step S26). Also, the controller 200 sets the sheet profile information set at Step S26 for the paper feed tray which houses the sheet S.

If at Step S24 the user operates the operation display panel 240 so as to tell that the detected area is not the white area (determination at Step S24: NO), the controller 200 or the user proceeds to the detection area correction process (Step S25).

The detection area correction process may be performed as follows. For example, the controller 200 causes the operation display panel 240 to show an instruction to change the orientation of the sheet S placed in the large-capacity paper feed unit 10 or the paper feed tray of the image forming device 20. If the image forming device 20 is provided with a manual feed tray and the way the sheet S is placed in the paper feed tray is fixed, the user may be instructed to feed the sheet S through the manual feed tray. Consequently, the base area M1 of the sheet S can pass through the detection area Q1 covered by the detector 520 as shown in FIG. 7B.

As another detection area correction method, if the detection area Q1 covered by the detector 520 can move widthwise, the controller 200 may cause the operation display panel 240 to show an instruction to move the detector 520 widthwise to a position where the base area M1 of the sheet S passes through the detection area Q1.

As a further alternative detection area correction method, the case that the inline media sensor 50 has a drive to move the detector 520 widthwise is described below. First, the image data on the sheet S as read by the image reader 30 is sent to the controller 200 of the image forming device 20. Then, the controller 200 identifies the white area or base area M1 of the sheet S according to the received image data. Then, the controller 200 sends a drive signal to the inline media sensor 50 according to the position of the identified base area M1. This changes the positional relation between the detection area Q1 covered by the detector 520 and the sheet S.

Furthermore, the controller 200 may instruct the user, through the operation display panel 240, to specify the position of the base area M1 of the sheet S for the setting process, using the thumbnail 247 shown on the operation display panel 240.

Then, the inline media sensor 50 moves the detector 520 widthwise according to the drive signal from the controller 200. Consequently, the position of the detection area Q1 of the inline media sensor 50 can be automatically adjusted according to the base area M1 of the sheet S.

As the detection area correction process is finished as mentioned above, the image forming system 1 returns to Step S21 and again performs the process to detect the white area of the sheet S. As explained above, in the second operation example in which the inline media sensor 50 is used, if the base (white) area of the sheet cannot be detected, the user is notified of the detection failure and prompted to take a remedial action, so the sheet S setting process can be performed even for the sheet S on which an image or text has already been formed.

### 2-4. Third Operation Example of the Sheet Setting Process

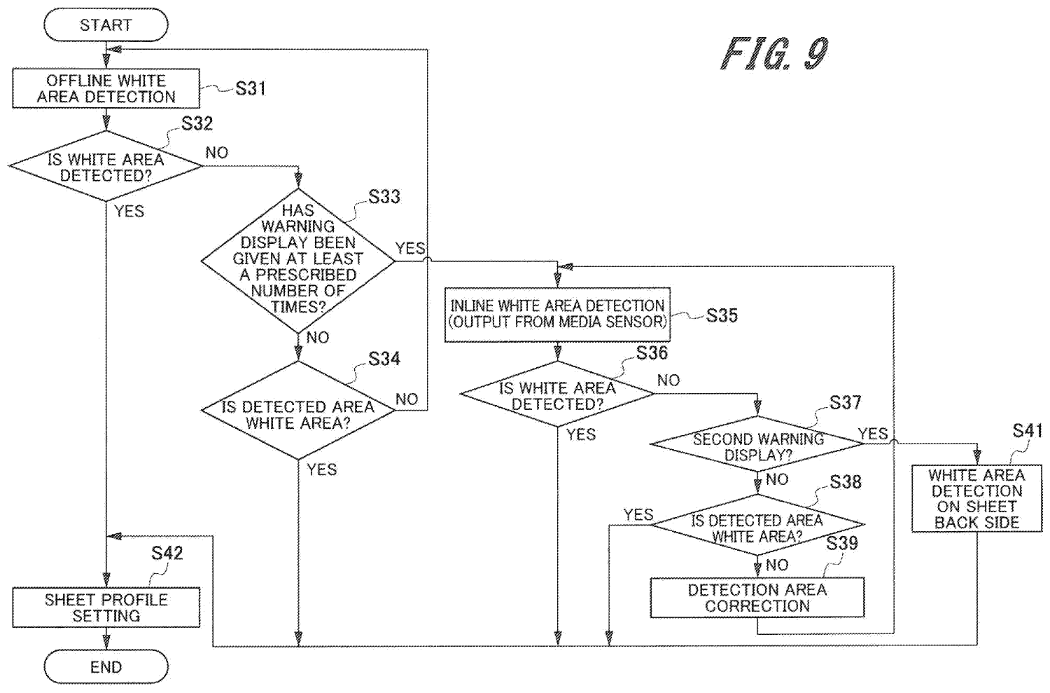

Next, as a third operation example of the sheet setting process, the case that both the inline media sensor 50 and offline media sensor 60 are used will be explained referring to FIG. 9.

FIG. 9 is a flowchart which shows the third operation example of the sheet setting process.

As shown in FIG. 9, first the user inserts the sheet S into the insertion hole 61 of the offline media sensor 60. Then, the white area of the sheet S is detected using the detector 620 of the offline media sensor 60 (Step S31). The offline media sensor 60 sends the information detected by the detector 620 of the offline media sensor 60 to the controller 200 of the image forming device 20 through the communication section 610. The controller 200 determines whether the white area has been detected according to the detected information sent from the detector 620 or not (Step S32).

If at Step S32 the controller 200 determines that the white area has not been detected (determination at Step S32: NO), it gives a warning display as shown in FIG. 5. The controller 200 prompts the user to change the orientation of the sheet S for insertion into the insertion hole 61 of the offline media sensor 60. Then, the controller 200 determines whether the warning display as shown in FIG. 5 has been given at least a prescribed number of times or not (Step S33).

If at Step S32 the controller 200 determines that the white area has been detected (determination at Step S32: YES), it compares the detected information sent from the detector 620 with the sheet setting information stored in the memory 250 in advance. Then, the controller 200 sets a sheet profile for the sheet S according to the detected information and the sheet setting information (Step S42). Also, the controller 200 sets the sheet profile information set at Step S42 for the paper feed tray which houses the sheet S.

Furthermore, if at Step S33 the controller 200 determines that the number of times of warning display is less than the prescribed number of times (determination at Step S33: NO), the controller 200 prompts the user to determine whether the detected area is the white area or not (Step S34). If at Step S34 the user operates the operation display panel 240 so as to tell that the detected area is the white area (determination at Step S34: YES), the controller 200 searches for a sheet profile approximate to the detected information sent from the detector 620 among the pieces of sheet setting information stored in the memory 250 in advance. Then, the controller 200 sets the approximate sheet profile as the sheet profile of the sheet S (Step S42). Also, the controller 200 sets the sheet profile information set at Step S42 for the paper feed tray which houses the sheet S.

If at Step S34 the user operates the operation display panel 240 so as to tell that the detected area is not the white area (determination at Step S34: NO), the controller 200 returns to Step S31. When returning to Step S31, the controller 200 causes the memory 250 to count the number of times of warning display. Then, the user should change the orientation of the sheet S for insertion into the insertion hole 61 and retry the process to detect the white area of the sheet S.

If at Step S33 the controller 200 determines that the number of times of warning display has reached the prescribed number of times or more (determination at Step S33: YES), the controller 200 switches the detection mode to the mode which uses the inline media sensor 50. In other words, the controller 200 causes the sheet S for the setting process to be transported from the large-capacity paper feed unit 10 or the paper feed tray of the image forming device 20. The white area of the transported sheet S is detected by the detector 520 of the inline media sensor 50 (Step S35).

Then, the inline media sensor 50 sends the information detected by the detector 520 to the controller 200 of the image forming device 20 through the communication section 510. The controller 200 determines whether the white area has been detected according to the detected information sent from the detector 520 or not (Step S36).

If at Step S36 the controller 200 determines that the white area has not been detected (determination at Step S36: NO), it gives a warning display as shown in FIG. 8. Then, the controller 200 determines whether the warning display as shown in FIG. 8 has been given at least twice or not (Step S37).

Then, if the controller 200 determines that the number of times of warning display, namely the number of times of detection made by the inline media sensor 50, is less than twice (determination at Step S37: NO), the controller 200 prompts the user to determine whether the detected area is the white area or not (Step S38).

If at Step S38 the user operates the operation display panel 240 so as to tell that the detected area is the white area (determination at Step S38: YES), the controller 200 searches for a sheet profile approximate to the detected information sent from the detector 520 among the pieces of sheet setting information stored in the memory 250 in advance. Then, the controller 200 sets the approximate sheet profile as the sheet profile of the sheet S (Step S42). Also, the controller 200 sets the sheet profile information set at Step S42 for the paper feed tray which houses the sheet S.

If at Step S38 the user operates the operation display panel 240 so as to tell that the detected area is not the white area (determination at Step S38: NO), the controller 200 or the user proceeds to the detection area correction process (Step S39). After the detection area correction process is finished, the image forming system 1 returns to Step S35 and again performs the process to detect the white area of the sheet S using the inline media sensor 50. At this time, the controller 200 causes the memory 250 to count the number of times of detection made by the inline media sensor 50 and the number of times of warning display.

If at Step S37 the controller 200 determines that the number of times of warning display, namely the number of times of detection made by the inline media sensor 50, has reached at least twice (determination at Step S37: YES), the controller 200 causes the inline media sensor 50 to detect the white area on the back side of the sheet S (Step S41). In other words, the controller 200 causes the inversion conveyor 290 to invert the sheet S for the setting process which is transported from the large-capacity paper feed unit 10 or the paper feed tray of the image forming device 20 and make the sheet S pass through the inline media sensor 50.

Then, the inline media sensor 50 detects the back side of the sheet S and sends a detection signal to the controller 200. The controller 200 treats the back side of the sheet S as a base area and sets a sheet profile (Step S42). The controller 200 sets the sheet profile information set at Step S42 for the paper feed tray which houses the sheet S. The setting process for the sheet S is thus finished. After the setting process for the sheet S is finished, the controller 200 resets the number of times of warning display as counted by the memory 250.

If the back side of the sheet S is treated as a base area to set a sheet profile, the controller 200 causes the operation display panel 240 to show information that the setting process has been performed using the back side of the sheet S. At Step S37, the threshold for sheet white area detection using the back side of the sheet is not limited to twice; instead, it may be once or three times or more. This threshold may be specified by the user when starting the setting process.

Although in the above operation examples it is assumed that the base area color of the sheet S is white, the base area color is not limited to white; instead, it may be another color, such as blue, red, yellow, or black. When starting the sheet setting process or during the sheet setting process, the controller 200 may prompt the user to specify the color of the base area using the operation display panel 240. Alternatively, the controller 200 may select the base area color from among the colors detected by the detector 520 of the inline media sensor 50 or the detector 620 of the offline media sensor 60. The selected base area color is stored in the memory 250 as a storage.

In some sheets S on which a graph or table has been plotted, ruled lines have already been drawn. If the detector 520 or 620 detects such ruled lines, the detected value changes within a given range, depending on the sheet insertion speed or sheet transportation speed. For this reason, when making a setting for the base area of the sheet S, the density threshold may be specified for the value detected by the detector 520 or 620. The specified threshold is stored in the memory 250.

Although in the explanation of the above examples it is assumed that the detected information is the color or density of the base area, the present invention is not limited thereto. The information on the sheet S which the inline media sensor 50 or offline media sensor 60 can detect and output includes the basis weight, thickness, surface nature, shape, resistance value, stiffness, percentage of moisture content, stains, creases, curls and so on.

Furthermore, in the above embodiment, when the controller 200 determines whether a given condition is met or not, specifically it determines whether the base area of the sheet S has been detected or not. However, the invention is not limited thereto. For example, instead, the controller 200 may determine whether the area detected by the inline media sensor 50 or offline media sensor 60 (detected information) is the text area or image area of the sheet S or not. Then, if the controller 200 determines that the detected information is only information on the text area or image area, the controller 200 determines that the given condition is not met and the controller 200 notifies the user through the notifying section such as the operation display panel 240 that the given condition is not met.

So far, the embodiment of the present invention and its advantageous effects have been described. However, the present invention is not limited to the above embodiment. The invention may be embodied in other various ways without departing from the gist of the present invention as described in the appended claims.

Although in the above embodiment, four image forming units are used to form a color image, an image forming device according to the present invention may use one image forming unit to form a monochrome image.

Furthermore, although in the above embodiment, the controller 200 of the image forming device 20 is used as the determination section which determines whether the base area has been detected or not, the invention is not limited thereto. For example, the controller of the external device (client terminal, management device server, mobile terminal, etc.) which sends job information to the image forming device 20 may be used as such a determination section.

Furthermore, although in the above embodiment, the operation display panel 240 of the image forming device 20 is used as the display section which shows the warning displays as shown in FIGS. 5 and 8, the invention is not limited thereto. The display section of the external device (client terminal, management device server, mobile terminal, etc.) which sends job information to the image forming device 20 may be used as such a display section.

Furthermore, the method for notifying the user that the base area has not been detected, namely the detected information does not meet the given condition or that the detection area correction process should be performed is not limited to a display on the operation display panel 240; instead, the user may be notified by voice.

The above elements, functions, processing sections and so on may be, in part or in whole, implemented by hardware such as integrated circuitry. Also, the above elements, functions and so on may be implemented by software so that a processor interprets and executes the program to perform the functions. The information such as programs, tables, and files to perform the functions may be stored in a recording device such as a memory, hard disk, or SSD (Solid State Drive) or in a recording medium such as an IC card, SD card, or DVD.

### REFERENCE SIGNS LIST

1 . . . image forming system,
10 . . . large-capacity paper feed unit,
20 . . . image forming device,
30 . . . image reader,
50 . . . inline media sensor (sheet detector),
60 . . . offline media sensor (sheet detector),
61 . . . insertion hole,
200 . . . controller (determination section),
210, 220 . . . communication section,
230 . . . paper conveyor
240 . . . operation display panel (notifying section),
241 . . . display screen,
247 . . . thumbnail,
250 . . . memory (storage),
260 . . . image processing section,
270 . . . image forming section,
290 . . . inversion conveyor,
360 . . . image reading section,
510, 610 . . . communication section,
520, 620 . . . detector,
M1 . . . base area,
M2 . . . image area,
Q1 . . . detection area

What is claimed is:

1. An image forming device comprising:
a communication section which receives, from a sheet detector for detecting a physical property value of a sheet, detected information acquired by detecting the sheet;
a determination section which determines whether the detected information received by the communication section meets a given condition or not; and
a notifying section which, if the determination section determines that the given condition is not met, notifies a user that the information detected by the sheet detector does not meet the given condition.

2. The image forming device according to claim 1, wherein the given condition is that the sheet detector has detected a base area of the sheet.

3. An image forming system comprising:
a sheet detector which detects a physical property value of a sheet;
an image forming device which forms an image on the sheet;
a determination section which determines whether the information detected by the sheet detector meets a given condition or not; and
a notifying section which, if the determination section determines that the given condition is not met, notifies a user that the information detected by the sheet detector does not meet the given condition.

4. The image forming system according to claim 3, wherein the given condition is that the sheet detector has detected a base area of the sheet.

5. The image forming system according to claim 3, wherein
the sheet detector is an offline media sensor which is located outside the image forming device and has an insertion hole into which the sheet is inserted; and
if the determination section determines that the given condition is not met, the determination section prompts the user to change an orientation of the sheet for insertion into the insertion hole, through the notifying section.

6. The image forming system according to claim 3,
wherein the sheet detector is an inline media sensor provided inside the image forming device,
the system further comprising:
a controller which, if the given condition is determined not to be met, performs a process to correct a detection area in which the inline media sensor detects the physical property value of the sheet.

7. The image forming system according to claim 6, wherein in the process to correct the detection area, the controller prompts the user to change an orientation of the sheet for transportation or change a position of a detector for detecting the physical property value of the sheet in the inline media sensor, through the notifying section.

8. The image forming system according to claim 6, wherein in the process to correct the detection area, the controller changes a positional relation between a detector for detecting the physical property value of the sheet in the inline media sensor, and the sheet.

9. The image forming system according to claim 8, further comprising:
an image reader which reads the image formed on the sheet,
wherein the controller changes the positional relation between the detector and the sheet according to image data read by the image reader.

10. The image forming system according to claim 6, wherein if the determination section determines that the inline media sensor has failed a prescribed number of times to meet the given condition, the determination section performs a process to detect the physical property value of a back side of the sheet.

11. The image forming system according to claim 6, wherein
the sheet detector comprises the inline media sensor and an offline media sensor which is located outside the image forming device and has an insertion hole for insertion of the sheet, and
if the determination section determines that the offline media sensor has failed a prescribed number of times to meet the given condition, the determination section performs a process to detect the physical property value of the sheet using the inline media sensor.

12. The image forming system according to claim 4, wherein the determination section performs a process to specify a color of the base area of the sheet.

13. An image forming system control method which uses a non-transitory computer-readable recording medium storing a program causing a computer to perform:
detecting a physical property value of a sheet and sending detected information to a determination section;
determining whether the detected information meets a given condition or not; and
if the given condition is determined not to be met, notifying a user that the given condition is not met.

14. A non-transitory computer-readable recording medium storing a program causing a computer to perform:
detecting a physical property value of a sheet and acquiring detected information;
causing a determination section to determine whether the detected information meets a given condition or not; and
if the determination section determines that the given condition is not met, causing a communication section to notify a user that the given condition is not met.
